(19) United States
(12) Patent Application Publication
(10) Pub. No.: US 2026/0003156 A1
(43) Pub. Date: Jan. 1, 2026

(54) OPTICAL APPARATUS AND CAMERA SYSTEM

(71) Applicant: CANON KABUSHIKI KAISHA, Tokyo (JP)

(72) Inventors: HIROKI OSAKA, Tochigi (JP); TOSHIHIRO OGAWA, Tokyo (JP); TORU ISHIMASA, Kanagawa (JP); YOSHIKAZU WATANABE, Chiba (JP)

(21) Appl. No.: 19/242,065

(22) Filed: Jun. 18, 2025

(30) Foreign Application Priority Data
Jun. 27, 2024 (JP) 2024-103808

(51) Int. Cl. G02B 7/16

(52) U.S. Cl. CPC G02B 7/16

(57) ABSTRACT

Provided is an optical apparatus comprising: a rotating member configured to allow an optical element to be moved in a direction along an optical axis; a protruding member configured to urge the rotating member in a direction different from a rotating direction of the rotating member; and a detection unit, wherein the rotating member includes a first region, a second region, and a third region set between the first region and the second region in the rotating direction, wherein the rotating member is subjected to a force in the rotating direction when being urged by the protruding member in the third region, and wherein a changing rate of an output of the detection unit is different for each of a first state in which the first region is opposed to the protruding member and a second state in which the second region is opposed to the protruding member.

### BACKGROUND

### Field of the Technology

The present disclosure relates to an optical apparatus and a camera system.

### Description of the Related Art

In Japanese Patent Laid-Open No. 2013-117457, there is disclosed an interchangeable lens including a detection device. The detection device synthesizes an output of a first potentiometer that detects a first range and an output of a second potentiometer that detects a second range being different from the first range to generate an output relating to positional detection.

### SUMMARY

According to the present disclosure, there is provided an optical apparatus comprising:
a rotating member configured to allow an optical element to be moved in a direction along an optical axis when being rotated about the optical axis;
a protruding member configured to urge the rotating member in a direction different from a rotating direction of the rotating member; and
a detection unit configured to detect information relating to a position of the rotating member in the rotating direction,
wherein the rotating member includes a first region, a second region, and a third region set between the first region and the second region in the rotating direction,
wherein the rotating member is subjected to a force in the rotating direction when being urged by the protruding member in the third region, and
wherein a changing rate of an output of the detection unit is different for each of a first state in which the first region is opposed to the protruding member and a second state in which the second region is opposed to the protruding member.

Features of the present disclosure will become apparent from the following description of embodiments with reference to the attached drawings. The following description of embodiments is described by way of example.

### BRIEF DESCRIPTION OF THE DRAWINGS

FIG. 1A is a front perspective view of a camera system of an embodiment, and FIG. 1B is a back perspective view of the camera system.

FIG. 2 is a block diagram for illustrating a configuration of the camera system of the embodiment.

FIG. 3 is a sectional view of an interchangeable lens (101) of the embodiment at a wide angle end (WE) at capturing time.

FIG. 4 is a sectional view of the interchangeable lens (101) of the embodiment at a telephoto end (TE) at the capturing time.

FIG. 5 is a sectional view of the interchangeable lens (101) of the embodiment at a retracted end (RE) at non-capturing time.

FIG. 6A is a perspective view of a rear lens unit (130) of the embodiment, and FIG. 6B is an exploded perspective view of the rear lens unit.

FIG. 7 is a perspective view of a zoom detection unit (106) of the embodiment.

FIG. 8A is a side sectional view of an urging mechanism (140) of the embodiment, and FIG. 8B is a bottom sectional view of the urging mechanism.

FIG. 9A is a schematic view for illustrating a position of a pin member (141) of the embodiment and an image pickup state, and FIG. 9B is an output characteristic graph of the zoom detection unit (106).

### DESCRIPTION OF THE EMBODIMENTS

Preferred embodiments of the present disclosure will now be described in detail in accordance with the accompanying drawings.

The same reference symbols denote the same or corresponding parts throughout the drawings. In this embodiment, an interchangeable lens 101, which is one example of an optical apparatus, is described. However, various modifications and changes are possible within the gist of the present disclosure. For example, the present disclosure is also applicable to a lens-integrated camera.

In recent years, optical apparatus such as digital cameras, video cameras, and interchangeable lenses are required to have improved portability to carry around. Some optical apparatuses are designed to be reduced in size, in particular, at non-capturing time by using a retracting mechanism. The retracting mechanism achieves a reduction in total length of an optical apparatus in an optical axis direction by reducing a distance between lens units at the time of transition from a capturable state to a retracted state in which capturing is restricted.

The resolution of detection can be exclusively increased for a part of a range by a detection device described in Japanese Patent Laid-Open No. 2013-117457. Thus, it is considered that, when such a detection device is used for the optical apparatus with the retracting mechanism, the resolution can be exclusively increased only for, in particular, a capturable range.

However, when a position for switching the resolution of the detection device between a capturable range and a retracted range in which capturing is restricted is shifted, there is a concern that the capturable state may be erroneously recognized as having transitioned to a capturing restricted state although the capturable state is maintained. As a result, a user may be unable to continue capturing although the user does not intend to stop capturing. On the contrary, when the capturing restricted state is erroneously recognized as having transitioned to the capturable state although capturing is still restricted, the results of capturing may be adversely affected.

The present disclosure is directed to provide an optical apparatus that enables correct recognition of an image pickup state.

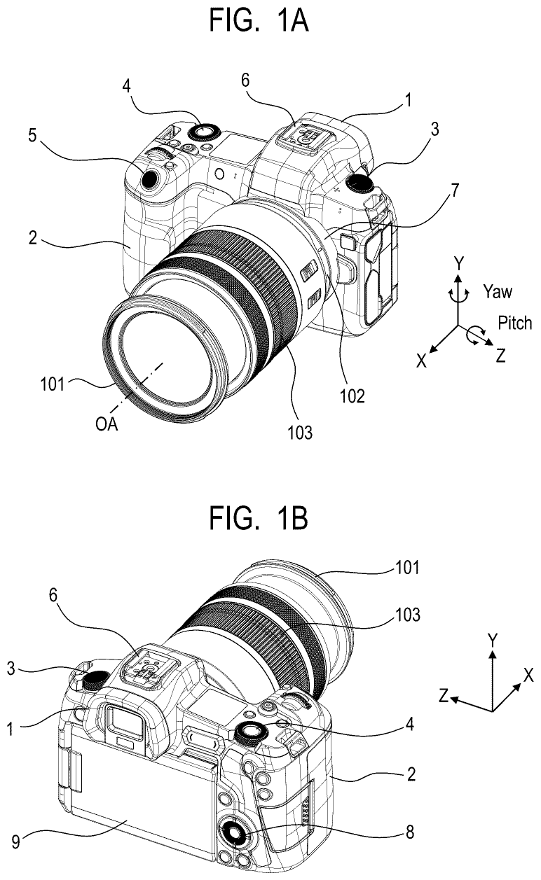

In FIG. 1A and FIG. 1B, the appearance of a camera system is illustrated. The camera system includes: the interchangeable lens 101 according to an embodiment of the present disclosure; and a digital camera (hereinafter referred to as “camera main body 1”) to which the interchangeable lens 101 is removably mounted. FIG. 1A and FIG. 1B are perspective views for illustrating a front side (object side) and a back side (image pickup plane side), respectively. In this embodiment, as illustrated in FIG. 1A, a direction in which an optical axis OA of an image pickup optical system housed in the interchangeable lens 101 extends is referred to as “X-axis direction (optical axis direction),” and directions orthogonal to the X-axis direction are referred to as “Z-axis direction (horizontal direction)” and “Y-axis direction (vertical direction),” respectively. The Z-axis direction and the Y-axis direction are hereinafter also referred to collectively as “Z/Y-axis directions.” Further, a rotating direction about the Z-axis is referred to as “pitch direction,” and a rotating direction about the Y-axis is referred to as “yaw direction.” The pitch direction and the yaw direction (hereinafter also referred to collectively as “pitch/yaw directions”) are rotating directions about two axes, namely the Z-axis and the Y-axis, that are orthogonal to each other.

A grip portion 2 that allows the user to grip the camera main body 1 by hand is provided to a left part of the camera main body 1 illustrated in FIG. 1A when viewed from the front side (right part when viewed from the back side). A power supply operating portion 3 is arranged on a top surface of the camera main body 1. When the user performs a switch-on operation on the power supply operating portion 3 while the camera main body 1 is in a power-off state, energization is started to bring the camera main body 1 into a power-on state. A computer program for home position detection processing for a focus lens unit or the like is executed, and the camera main body 1 is brought into a capturing standby state. Then, when the user performs a switch-off operation on the power supply operating portion 3 while the camera main body 1 is in a power-on state, the camera main body 1 is brought into a power-off state.

Further, a mode dial 4, a release button 5, and an accessory shoe 6 are provided on the top surface of the camera main body 1. When the user rotationally operates the mode dial 4, capturing modes can be switched. The capturing modes include a manual still image capturing mode, an automatic still image capturing mode, and a moving image capturing mode. In the manual still image capturing mode, the user can appropriately set capturing conditions such as a shutter speed and a stop value. In the automatic still image capturing mode, a proper exposure amount can be automatically obtained. The moving image capturing mode is used to capture a moving image. Further, when the user performs a halfway-pressing operation on the release button 5, a capturing preparation operation such as autofocusing or autoexposure control can be instructed. When the user performs a full-pressing operation on the release button 5, capturing can be instructed. An illumination or light-emitting device accessory (camera accessory) such as an external flash can be removably mounted onto the accessory shoe 6.

The interchangeable lens 101 includes a lens mount 102. The lens mount 102 can be mechanically and electrically connected to a camera mount 7 provided to the camera main body 1. The lens mount 102 and the camera mount 7, each having an annular shape, can be connected and disconnected through bayonet coupling (not shown). A combination of the interchangeable lens 101 and the camera main body 1 is not limited as long as common mount shapes are used as a camera system. The camera system includes: the camera main body 1 having the camera mount 7; and the interchangeable lens 101 described below in detail, which has the lens mount 102.

The image pickup optical system which images light from an object to form an object image is housed within the interchangeable lens 101. A rotating operation ring 103 (rotating member) that can be rotated about the optical axis OA by the operation performed by the user is provided on an outer periphery of the interchangeable lens 101. When the rotating operation ring 103 is rotationally operated by the user, a zoom lens unit 110 (optical elements) described later, which forms the image pickup optical system, is moved to a predetermined position of use corresponding to an angle of the rotating operation ring 103 within the range from a wide angle end WE to a telephoto end TE. That is, the zoom lens unit 110 can be moved in a direction along the optical axis OA through the rotation of the rotating operation ring 103 about the optical axis OA. In this manner, the user can perform capturing at a desired angle of field. Further, in the present disclosure, there is set a retracted end RE at which capturing is further restricted after the rotating operation ring 103 is rotationally operated from the telephoto end TE to the wide angle end WE, which is described later in detail. The retracted end RE is a position at which the interchangeable lens 101 is most retracted.

As illustrated in FIG. 1B, a back operating portion 8 and a display portion 9 are provided on a back surface of the camera main body 1. The back operating portion 8 includes a plurality of buttons and dials to which various functions have been allocated. When the camera main body 1 is in a power-on state and the still image capturing mode or the moving image capturing mode is set, a through-the-lens image of the object image being picked up by an image pickup element 16 described later is displayed on the display portion 9. Further, capturing parameters indicating capturing conditions, such as a shutter speed and a stop value, are displayed on the display portion 9. The user can change setting values of the capturing parameters by operating the back operating portion 8 while viewing the display. The back operating portion 8 includes a playback button for instructing the playback of a captured image that has been recorded. When the user operates the playback button, the captured image is played back and displayed on the display portion 9. The display portion 9 may be formed as a touch panel so as to have the same functions as those of the back operating portion 8.

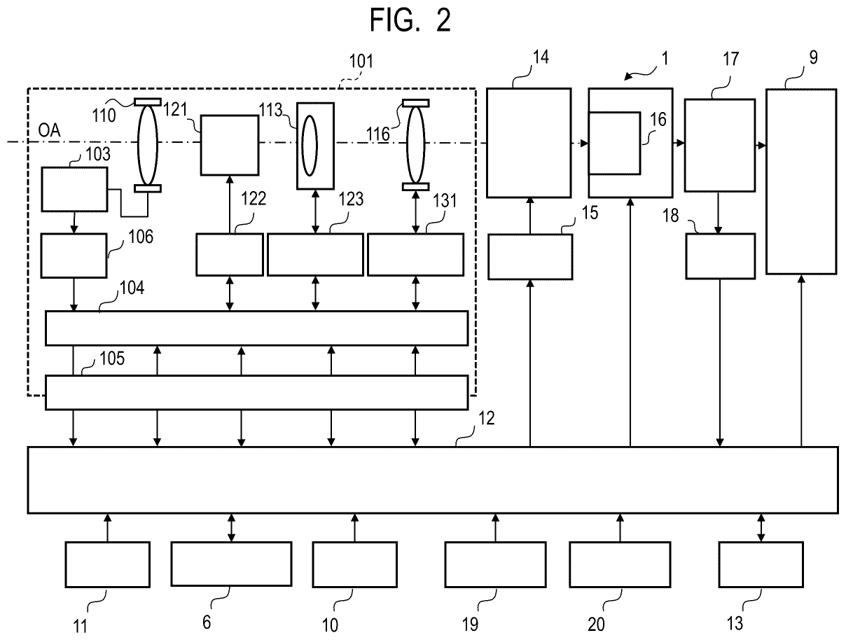

FIG. 2 is a block diagram for illustrating electrical and optical configurations of the camera system including the interchangeable lens 101 and the camera main body 1. The camera main body 1 includes a power supply unit 10 and an operation portion 11. The power supply unit 10 supplies electric power to the camera main body 1 and the interchangeable lens 101. The operation unit 11 includes the power supply operating portion 3, the mode dial 4, the release button 5, the back operating portion 8, and a touch panel function of the display portion 9 described above. The overall system including the camera main body 1 and the interchangeable lens 101 in this embodiment is controlled through the cooperation of a camera control unit 12 of the camera main body 1 and a lens control unit 104 of the interchangeable lens 101. Computers for controlling the camera main body 1 and the interchangeable lens 101 are built in the camera control unit 12 and the lens control unit 104, respectively. The overall system including the camera main body 1 and the interchangeable lens 101 is controlled through the cooperative operation of the computers.

The camera control unit 12 reads out and executes the computer program stored in a storage unit 13. At this time, the camera control unit 12 communicates with the lens control unit 104 for various control signals, data, and the like through a communication terminal of an electric contact 105 provided to the lens mount 102. The electric contact 105 includes a power supply terminal for supplying the electric power from the power supply unit 10 described above to the interchangeable lens 101.

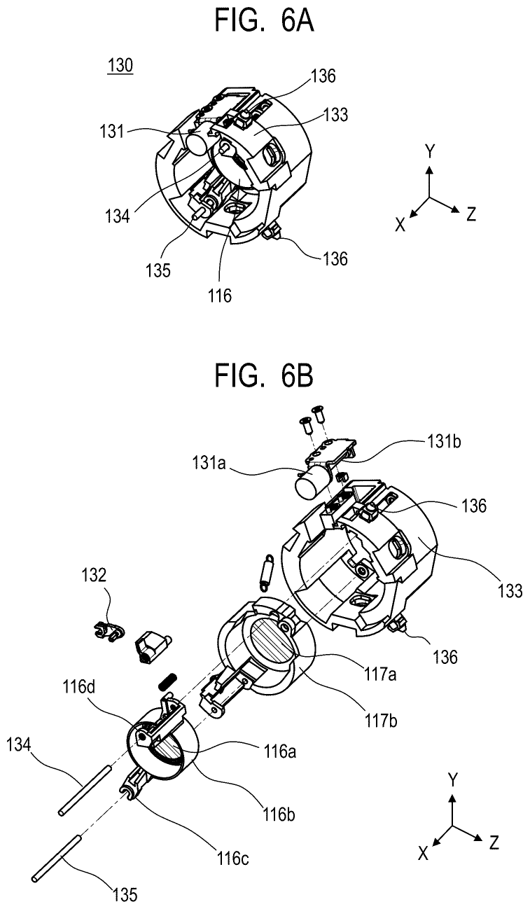

The image pickup optical system of the interchangeable lens 101 includes the zoom lens unit 110 and a stop unit 121. The zoom lens unit 110 is coupled to the rotating operation ring 103 and is moved in the direction along the optical axis OA to change an angle of field. The stop unit 121 performs a light amount adjustment operation. Further, the image pickup optical system includes a lens vibration isolation unit 113 including a shift lens serving as a vibration isolation element. The lens vibration isolation unit 113 is moved (shifted) in the Z/Y-axis directions being orthogonal to the optical axis OA to thereby reduce image blur. Further, the image pickup optical system includes a focus lens unit 116 including a focus lens 116a (see FIG. 6B). The focus lens 116a is moved in the optical axis direction to perform focus adjustment. The interchangeable lens 101 includes: a stop drive unit 122 which drives the stop unit 121; a vibration isolation drive unit 123 which moves the lens vibration isolation unit 113; and a focus drive unit 131 which moves the focus lens unit 116.

The camera main body 1 includes a shutter unit 14, a shutter drive unit 15, the image pickup element 16, an image processing unit 17, and the camera control unit 12 described above. The shutter unit 14 controls the amount of light, which is imaged through the image pickup optical system provided in the interchangeable lens 101 and then strikes the image pickup element 16. The image pickup element 16 photoelectrically converts the object image formed through the image pickup optical system to output an image pickup signal. The image processing unit 17 performs various kinds of image processing on the image pickup signal and then generates an image signal. The display portion 9 displays the image signal (through-the-lens image) output from the image processing unit 17, displays the capturing parameters as described above, and plays back and displays a captured image recorded in the storage unit 13 or a recording medium (not shown).

The camera control unit 12 controls the focus drive unit 131 in accordance with a capturing preparation operation performed on the operation portion 11 (such as a halfway-pressing operation on the release button 5). When, for example, an autofocusing operation is instructed, a focus detection unit 18 determines a focus state of the object image formed through the image pickup element 16 based on the image signal generated in the image processing unit 17, generates a focus signal, and transmits the focus signal to the camera control unit 12. At the same time, the focus drive unit 131 transmits information relating to a current position of the focus lens unit 116 to the camera control unit 12. The camera control unit 12 compares the focus state of the object image and the current position of the focus lens unit 116, calculates a focus drive amount from a shift amount therebetween, and transmits the calculated focus drive amount to the lens control unit 104. Then, the lens control unit 104 moves the focus lens unit 116 to a target position in the optical axis direction through intermediation of the focus drive unit 131 to thereby correct a focus deviation of the object image.

The focus drive unit 131 includes: a focus motor 131a (see FIG. 6B) functioning as an actuator; and a photo interrupter which detects a home position of the focus lens unit 116. In general, a stepping motor, which is a kind of actuator, is often adopted as the focus motor 131a. A DC motor or an ultrasonic motor, each including an encoder, a servo motor or the like may be used as the focus motor 131a. Further, the photo interrupter directly receives light emitted from a light emitting portion at a light receiving portion. In place of the photo interrupter, a photo reflector, which receives reflected light from a reflective surface, or a brush, which is brought into contact with a conductor pattern to electrically detect a signal, may be used as the detection unit.

The camera control unit 12 controls the driving of the stop unit 121 and the shutter unit 14 through intermediation of the stop drive unit 122 and the shutter drive unit 15 in accordance with the setting values such as the stop value and the shutter speed, which are received from the operation portion 11. When, for example, an autoexposure control operation is instructed, the camera control unit 12 receives a luminance signal generated in the image processing unit 17 and performs a photometric calculation. Based on the result of this photometric calculation, the camera control unit 12 controls the stop drive unit 122 in accordance with a capturing instruction operation performed on the operation portion 11 (such as a full-pressing operation on the release button 5). Along therewith, the camera control unit 12 controls the driving of the shutter unit 14 through intermediation of the shutter drive unit 15 so that the image pickup element 16 is subjected to exposure processing.

The camera main body 1 includes a pitch shake detection unit 19 and a yaw shake detection unit 20 as shake detection units capable of detecting image blur caused by user's camera shake or the like. The pitch shake detection unit 19 and the yaw shake detection unit 20 detect image blur in the pitch direction (rotating direction about the Z-axis) and the yaw direction (rotating direction about the Y-axis), respectively, by using an angular velocity sensor (vibration gyro sensor) or an angular acceleration sensor and each output a shake signal.

The camera control unit 12 calculates a shift position of the lens vibration isolation unit 113 in the Y-axis direction by using the shake signal output from the pitch shake detection unit 19. Similarly, the camera control unit 12 calculates a shift position of the lens vibration isolation unit 113 in the Z-axis direction by using the shake signal output from the yaw shake detection unit 20. Then, the camera control unit 12 moves the lens vibration isolation unit 113 to a target position in the Z/Y-axis directions through intermediation of the vibration isolation drive unit 123 in accordance with the calculated shift positions in the pitch/yaw directions to thereby reduce image blur during exposure or through-the-lens image display.

The interchangeable lens 101 includes: the rotating operation ring 103 which changes the angle of field of the image pickup optical system; and a zoom detection unit 106 (detection unit) which detects an angle of the rotating operation ring 103, as described later in detail. The zoom detection unit 106 detects the angle of the rotating operation ring 103 operated by the user as an absolute value, and includes, for example, a resistive linear potentiometer. Information relating to a focal length (information relating to the movement of the optical element) detected by the zoom detection unit 106 is reflected in various kinds of control performed by the camera control unit 12 described above and is recorded together with the captured image in the storage unit 13 or a recording medium (not shown). In other words, the zoom detection unit 106 detects information relating to the position of the rotating operation ring 103 in its rotating direction.

Information of the target position of the focus lens unit 116 to focus on each in-focus position from infinity to close proximity at each focal length from the wide angle end WE to the telephoto end TE is stored as data in the lens control unit 104. The driving of the focus lens unit 116 is controlled based on the data described above and angle information of the rotating operation ring 103, which is detected by the zoom detection unit 106. In this case, when the focal length is continuously changed from the wide angle end WE to the telephoto end TE, the focus lens unit 116 is controlled with different movement loci depending on the focus state. That is, the focus lens unit 116 has different movement loci for zooming performed while the focus lens unit 116 is focused on infinity and for zooming performed while the focus lens unit 116 is focused on close proximity.

In general, when the F-number becomes smaller to indicate higher brightness or the focal length at the telephoto end TE becomes longer, a depth of focus decreases and focus deviation occurring when zooming is performed becomes less allowable. Further, when the focal length at the wide angle end WE is particularly short, the image processing performed by the camera control unit 12 is sometimes used to electronically correct optical distortion. The relatively highly functional and high performance interchangeable lens as described above is required to detect the angle information of the rotating operation ring 103 with higher precision. Thus, the resolution of the zoom detection unit 106 is extremely important.

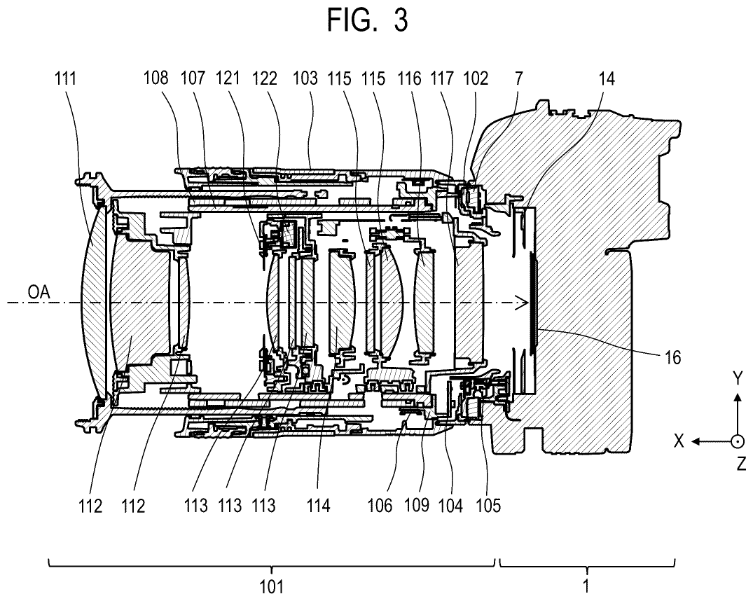

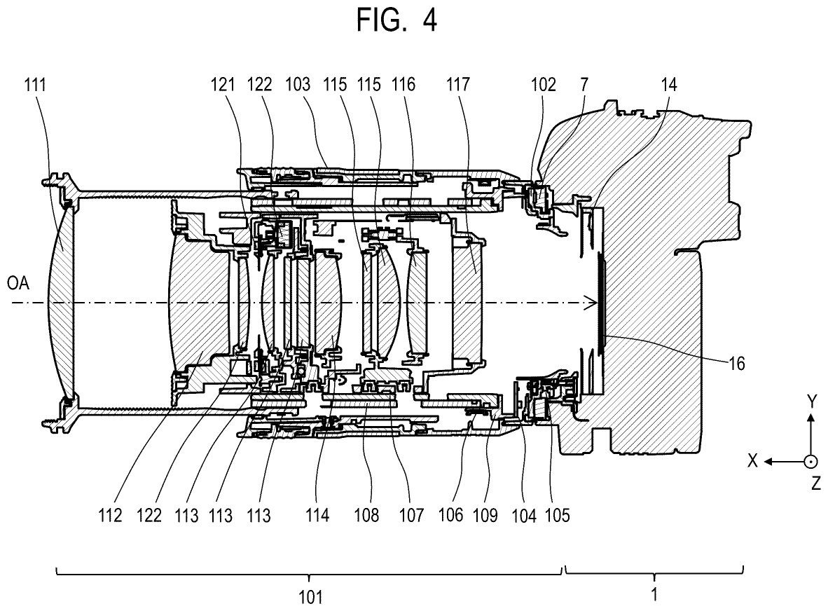

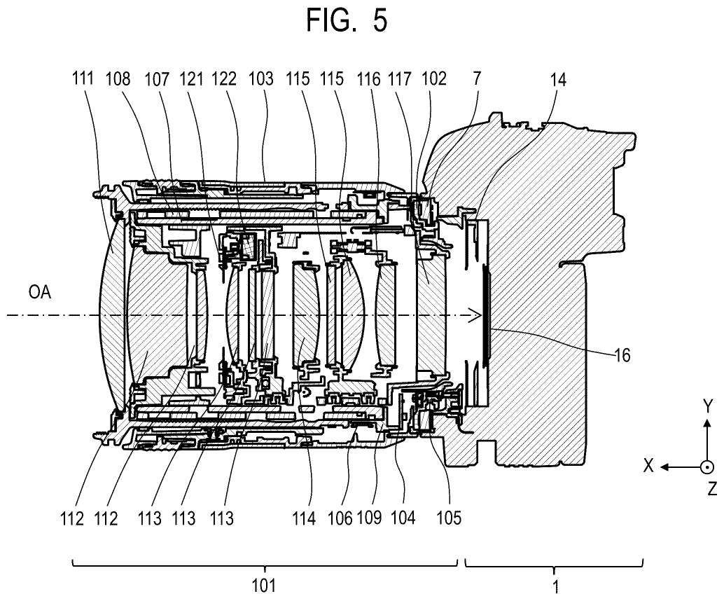

Next, with reference to FIG. 3, FIG. 4, and FIG. 5, a positional relationship among relevant components of the interchangeable lens 101 is described. FIG. 3, FIG. 4, and FIG. 5 are sectional views taken along an XY plane including the optical axis OA. A center line described herein substantially matches with the optical axis OA determined by the image pickup optical system and thus is hereinafter regarded as being synonymous with the optical axis OA. In FIG. 3, the positional relationship among the components at the wide angle end WE on a short focal length side in zooming at capturing time is illustrated. In FIG. 4, the positional relationship among the components at the telephoto end TE on a long focal length side in zooming at the capturing time is illustrated. Further, in FIG. 5, the positional relationship among the components at the retracted end RE at non-capturing time when the total length becomes the shortest in the optical axis direction is illustrated.

In both of FIG. 3 and FIG. 4, the image pickup optical system of the interchangeable lens 101 is located at a capturable position (in the capturable state). Meanwhile, in FIG. 5, the image pickup optical system of the interchangeable lens 101 at the non-capturing time is in a housed state (state in which the image pickup optical system is at a retracted position).

The retracted end RE illustrated in FIG. 5 is set inside the wide angle end WE of FIG. 3. The focal length is changed in order from the retracted end RE of FIG. 5 to the wide angle end WE of FIG. 3 and then from the wide angle end WE illustrated in FIG. 3 to the telephoto end TE illustrated in FIG. 4 through the rotational operation of the rotating operation ring 103 in one direction. In this embodiment, a state in which the image pickup optical system can perform capturing is referred to as “image pickup,” and a state in which the image pickup optical system is at the retracted position is referred to as “retracted state (non-image pickup state).” The term “capturable state” means that the functions as the camera including the camera main body 1 and the interchangeable lens 101 can work normally at any time. The term “restricted capturing” means that some of the functions of the camera including the camera main body 1 and the interchangeable lens 101 do not work normally. For example, under a state in which the image pickup optical system is at the retracted position, a capturing action itself (for example, pressing the shutter button to photograph an object) is possible. However, the image may be entirely or partially blurred because the captured image is out of focus or the like.

As illustrated in FIG. 3 and FIG. 4, in this embodiment, a seven-unit configuration is adopted as an example of the image pickup optical system. The zoom lens unit 110 configured to be movable in the optical axis direction is moved to a different predetermined position of use for each of the wide angle end WE and the telephoto end TE and images the light from the object onto the image pickup element 16. The zoom lens unit 110 includes a first zoom lens unit 111, a second zoom lens unit 112, the lens vibration isolation unit 113, a fourth zoom lens unit 114, a fifth zoom lens unit 115, the focus lens unit 116, a seventh zoom lens unit 117, and the stop unit 121. It is noted that the lens vibration isolation unit 113 functions as a third zoom lens unit and the focus lens unit 116 functions as a sixth zoom lens unit. The present disclosure does not limit the configuration of the image pickup optical system, and, for example, the lens vibration isolation unit 113 or the focus lens unit 116 may function as another zoom lens unit. Further, some of the lens units may be fixed instead of being movable.

A straight guide barrel 107 is a fixed component that is fixed to the lens mount 102 through intermediation of a fixed barrel 109 (fixed member) described later. Bayonet claws (not shown) are arranged at equiangular positions on an outer peripheral surface of the straight guide barrel 107. Meanwhile, a circumferential groove (not shown) is formed in an inner peripheral surface of a cam barrel 108. Further, the cam barrel 108 is coupled to the rotating operation ring 103. When the user rotationally operates the rotating operation ring 103, the cam barrel 108 is restricted from being moved in the optical axis direction and is rotated about the optical axis OA as a result of the fitting of the bayonet claws into the circumferential groove. That is, the fixed barrel 109 (holding member) holds the rotating operation ring 103 so that the rotating operation ring 103 is rotatable about the optical axis.

Further, straight guide grooves for restricting the movement of the zoom lens unit 110 in the rotating direction and guiding the linear movement of the zoom lens unit 110 in the optical axis direction are formed at equiangular positions on the straight guide barrel 107. Further, cam grooves having loci at different angles in the rotating direction are similarly formed at equiangular positions on the cam barrel 108 so as to correspond to the zoom lens unit 110. Meanwhile, a plurality of rollers is provided to the zoom lens unit 110. The rollers are fitted into corresponding ones of the straight guide grooves and the cam grooves. When the user rotationally operates the rotating operation ring 103, the cam barrel 108 is rotated. As a result of fitting of the rollers into the straight guide grooves and the cam grooves, the zoom lens unit 110 is advanced and retreated in the optical axis direction while being restricted from moving in the rotating direction.

The interchangeable lens 101 of this embodiment has a retracting mechanism that allows the zoom lens unit 110 to be retracted. At the non-capturing time, the zoom lens unit 110 can be further retracted to the back side (image pickup plane side). At the wide angle end WE illustrated in FIG. 3, a distance between the second zoom lens unit 112 and the lens vibration isolation unit 113 (third zoom lens unit) is large. At the telephoto end TE illustrated in FIG. 4, a distance between the first zoom lens unit 111 and the second zoom lens unit 112 is large. The retracting mechanism reduces each of the distances described above and moves the zoom lens unit 110 to a housing position at which the zoom lens units are close to each other to thereby reduce the total length in the optical axis direction.

As illustrated in FIG. 5, at the retracted end RE at the non-capturing time, the zoom lens unit 110 has been moved to and is located at the housing position at which the zoom lens units are close to each other. As a result, a reduction in the total length of the interchangeable lens 101 is achieved to thereby improve the portability of the interchangeable lens 101 and the camera main body 1. When the user rotationally operates the rotating operation ring 103, for example, to the wide angle end WE under the above-mentioned state, the zoom lens unit 110 is extended to the front side (object side) and is moved to a predetermined position of use to thereby reach the capturable state illustrated in FIG. 3. Such a retracting mechanism is a publicly known technology that has been adopted in many optical apparatuses so far, and hence the detailed description thereof is omitted.

In FIG. 6A and FIG. 6B, members (components) of a rear lens unit 130 of this embodiment are extracted and illustrated as viewed from the front side (object side). FIG. 6A is a perspective view of the components in the capturable state, and FIG. 6B is an exploded perspective view for illustrating some of the components illustrated in FIG. 6A in a separated manner.

The rear lens unit 130 includes a moving barrel 133. The focus lens unit 116 is housed in the moving barrel 133. The focus lens unit 116 includes the focus lens 116a and a focus lens holding frame 116b that holds the focus lens 116a. Further, the seventh zoom lens unit 117 includes a seventh unit lens 117a and a seventh unit lens holding frame 117b that holds the seventh unit lens 117a.

The focus lens holding frame 116b includes a sleeve portion 116c and a vibration stopper portion 116d. The sleeve portion 116c is slidably fitted over a main guide 135 that is arranged substantially in parallel to the optical axis OA, and the vibration stopper portion 116d is slidably fitted over a sub guide 134 that is arranged substantially in parallel to the main guide 135. Axial ends of each of the main guide 135 and the sub guide 134 are supported by the moving barrel 133 and a cap member (not shown), respectively. In this manner, the focus lens unit 116 is positioned in the Y-axis direction and the Z-axis direction by the main guide 135 and the sub guide 134 and is smoothly movable in the optical axis direction (X-axis direction).

The focus drive unit 131 including the focus motor 131a and a feed screw 131b (meshing portion) is fixed onto the moving barrel 133. A rack 132 is meshed with the feed screw 131b. A rotary shaft portion of the rack 132 is engaged with a fitting hole of the focus lens holding frame 116b and is allowed to only rotate inside the fitting hole. Even when slight runout of the feed screw 131b occurs due to a variation in processing accuracy or the like, the rack 132 can stably convert a rotational driving force of the focus motor 131a into a thrust force in the optical axis direction.

Three moving rollers 136 are provided at equiangular positions on an outer peripheral surface of the moving barrel 133. As described above, the moving rollers 136 are fitted into corresponding ones of the straight guide grooves and the cam grooves. When zooming is performed, for example, from the wide angle end WE to the telephoto end TE, the cam barrel 108 is rotated and the moving barrel 133 is linearly moved integrally with the components such as the focus lens unit 116 in the optical axis direction.

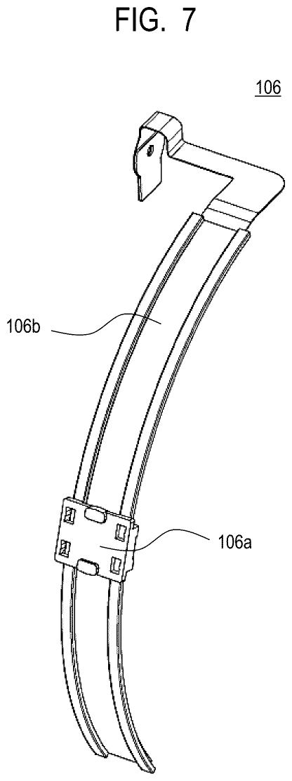

Now, the zoom detection unit 106, which is one of the features of the present disclosure, is described in detail with reference to FIG. 7. FIG. 7 is a perspective view for illustrating a front side (object side) of the zoom detection unit 106.

The zoom detection unit 106 includes a movable portion 106a and a fixed portion 106b. The movable portion 106a includes brushes and is formed of a sheet metal. The fixed portion 106b has circuit patterns formed on its surface. The circuit patterns include a conductor pattern, a resistor pattern, and a wiring pattern. The conductor pattern includes a layer of carbon as a protective film laminated on an upper surface of a pattern formed of a conductive material such as gold or silver. Meanwhile, the resistor pattern has only a pattern of carbon. The resistor pattern has a larger electrical resistance per unit length in a circumferential direction than that of the conductor pattern. The wiring pattern is connected to the lens control unit 104 through intermediation of a flexible circuit board.

The conductor pattern, the resistor pattern, and the wiring pattern are formed in parallel on the fixed portion 106b so as to extend in a longitudinal direction. The brushes of the movable portion 106a are in sliding contact with the conductor pattern and the resistor pattern. A voltage is applied to another end of the conductor pattern, and one end of the resistor pattern is grounded.

The fixed portion 106b is fixed to the fixed barrel 109, and the movable portion 106a is coupled to the rotating operation ring 103 through intermediation of a coupling member (not shown). The movable portion 106a is moved in association with the rotating operation ring 103. Thus, the interchangeable lens 101 is moved beyond the range from the telephoto end TE to the wide angle end WE, which corresponds to the image pickup state, to the position of the retracted end RE corresponding to the non-image pickup state. In this embodiment, the fixed portion 106b is fixed to the fixed barrel 109. However, the movable portion 106a may be fixed to the fixed barrel 109.

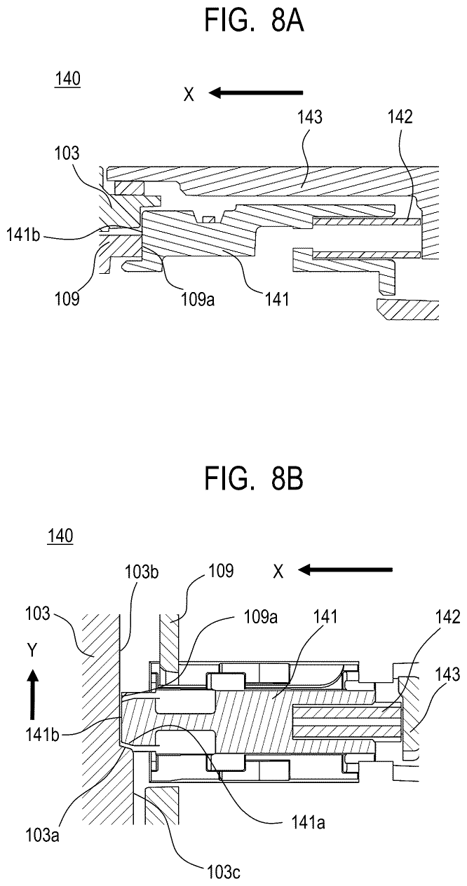

The interchangeable lens 101 of this embodiment includes an urging mechanism 140 that provides a tactile clicking sensation to the user when the user performs a zooming operation. Next, a mechanism for providing a tactile clicking sensation is described. FIG. 8A is a side sectional view of the urging mechanism 140, and FIG. 8B is a bottom sectional view when viewed from the optical axis center. FIG. 8A and FIG. 8B both correspond to the capturable state and are views for illustrating a relative positional relationship of the urging mechanism 140 in the vicinity of a capturing end.

As illustrated in FIG. 8B, the urging mechanism 140 includes the fixed barrel 109, a pin member 141 (engaging member, protruding member), an inclined portion 103a, an exterior ring 143, and an urging member 142. The inclined portion 103a is a part of the rotating operation ring 103. Further, the rotating operation ring 103 is schematically illustrated as being moved in the Y direction with respect to the pin member 141. Actually, however, the rotating operation ring 103 is not moved in parallel in the Y-axis direction but is moved rotationally about the optical axis OA. The pin member 141 is restricted from being moved in the Y direction by the fixed barrel 109 while being movably held by the fixed barrel 109 so as to be linearly movable in the X direction, which is parallel to the optical axis OA.

A distal end portion 141b is formed integrally with the pin member 141. A tapered portion 141a is formed on a side surface portion being adjacent to the distal end portion 141b. The urging member 142 is received in a cylindrical recessed portion of the pin member 141. Under a reaction force from the exterior ring 143, the urging member 142 urges the pin member 141 in the X direction toward the rotating operation ring 103. That is, the urging mechanism 140 (pin member 141) is configured to urge the rotating operation ring 103 in the X direction that is different from the rotating direction of the rotating operation ring 103. The urging member 142 of this embodiment is a compression coil spring as an example and is arranged on the side opposite to the distal end portion 141b of the pin member 141. However, the urging member 142 may have any configuration and shape as long as the urging member 142 can urge the pin member 141 in the X direction.

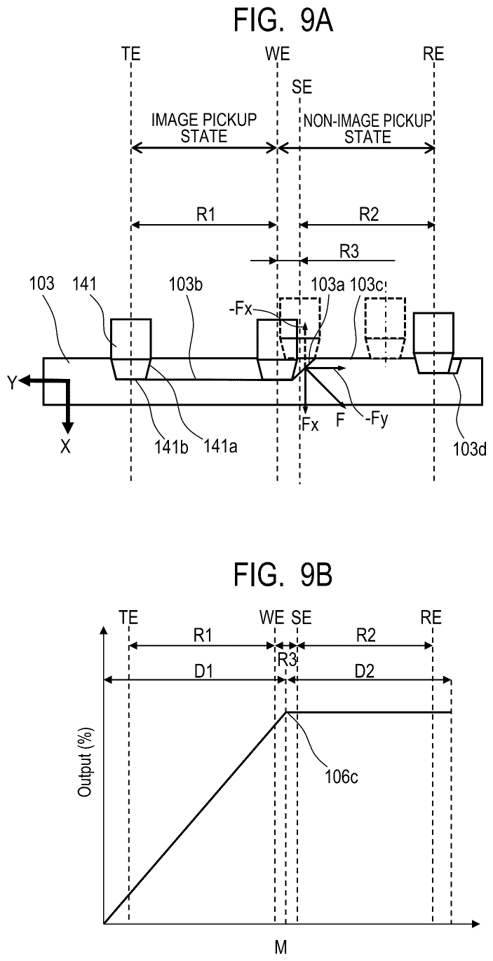

A first flat surface portion 103b, a second flat surface portion 103c, the inclined portion 103a, and a third flat surface portion 103d (see FIG. 9A) are integrally formed on an inner peripheral surface of the rotating operation ring 103. Each of the first flat surface portion 103b and the second flat surface portion 103c is a plane orthogonal to the optical axis. The inclined portion 103a is inclined with respect to the plane orthogonal to the optical axis. As illustrated in FIG. 8A, when the interchangeable lens 101 is in the image pickup state, the distal end portion 141b of the pin member 141 is in abutment against an abutment portion 109a of the fixed barrel 109. Thus, the urging force of the urging member 142 is not applied to the rotating operation ring 103.

When the rotating operation ring 103 is rotationally operated in the Y direction by the user, the inclined portion 103a of the rotating operation ring 103 and the tapered portion 141a of the pin member 141 are brought into abutment and engagement with each other to thereby stop the rotation of the rotating operation ring 103. When the rotating operation ring 103 is further rotationally operated in the Y direction, the pin member 141 is moved in the-X direction by the inclined portion 103a to cause the distal end portion 141b of the pin member 141 to run on the inclined portion 103a. At this time, the urging member 142 is compressed, and an operation reaction force F generated as a result of compression is transmitted to the rotating operation ring 103 through the inclined portion 103a and acts as a load resistance against the rotating operation. The load resistance is applied within a limited section until the distal end portion 141b climbs over the inclined portion 103a. Thus, a change in rotational torque is caused locally and is perceived by the user as a tactile clicking sensation. It is difficult to stop the rotating operation ring 103 in that section because of a locally caused change in rotational torque. That is, a tactile clicking sensation, which is perceived by the user, is produced by a reaction force from the rotating operation ring 103 to the pin member 141.

In the urging mechanism 140, a tactile clicking sensation suitable for the rotating operation of the rotating operation ring 103 can be set by appropriately changing an angle between the inclined portion 103a and the tapered portion 141a and the urging force of the urging member 142. This tactile clicking sensation allows the user to perceive switching (change) from the image pickup state in which capturing can be performed to the non-image pickup state in which capturing cannot be performed.

Next, a relationship between timing at which the operation reaction force F is generated by the urging mechanism 140 and a switching position 106c for the output of the zoom detection unit 106 is described with reference to FIG. 9A and FIG. 9B. FIG. 9A is a schematic view for illustrating a relationship between the position of the pin member 141 and the image pickup state, and FIG. 9B is an output characteristic graph for showing a relationship of an output change Output with respect to a movement amount M of the movable portion 106a of the zoom detection unit 106.

FIG. 9A has the horizontal axis representing a rotation phase (Y) of the rotating operation ring 103. In FIG. 9A, a relative positional relationship of the components during zooming is schematically illustrated, representing the movement of the pin member 141 relative to the rotating operation ring 103. However, the rotating operation ring 103 is actually rotated, and the position of the pin member 141 in the Y direction is fixed by the fixed barrel 109.

The rotating operation ring 103 has the first flat surface portion 103b corresponding to the image pickup state and the second flat surface portion 103c corresponding to the non-image pickup state, which are formed on a plane orthogonal to the optical axis OA. The inclined portion 103a is formed so as to connect the first flat surface portion 103b and the second flat surface portion 103c. A rotation range of the rotating operation ring 103 when the pin member 141 is in sliding contact with the first flat surface portion 103b that is formed between the telephoto end TE and the wide angle end WE is set as a first rotation range R1 (first region), and the interchangeable lens 101 can be changed from the telephoto end TE to the wide angle end WE. A rotation range in which the rotating operation ring 103 is rotated from the wide angle end WE at which the pin member 141 is brought into sliding contact with the inclined portion 103a to an inclination end SE at which the pin member 141 climbs over the inclined portion 103a is set as a transition range. In this range, the interchangeable lens 101 is in the non-image pickup state. A rotation range in which the pin member 141 is in sliding contact with the second flat surface portion 103c lying between the inclination end SE and the retracted end RE is set as a second rotation range R2 (second range). When the rotating operation ring 103 is rotated, the interchangeable lens 101 is gradually retracted while remaining in the non-image pickup state. Then, when the pin member 141 is brought into abutment and engagement with the third flat surface portion 103d at the retracted end RE, the rotation of the rotating operation ring 103 is stopped and the interchangeable lens 101 is completely retracted. When the pin member 141 is positioned on the third flat surface portion 103d, the image pickup optical system is located at the retracted position. The transition range is a third rotation range R3 (third region) that connects the first rotation range R1 and the second rotation range R2. That is, the rotating operation ring 103 includes the first rotation range R1, the second rotation range R2, and the third rotation range R3 that is set between the first rotation range R1 and the second rotation range R2 in the rotating direction. Further, when the rotating operation ring 103 is urged by the pin member 141 in the third rotation range R3, the rotating operation ring 103 is subjected to a force in the rotating direction.

When the rotating operation ring 103 is rotationally operated within the range from the telephoto end TE to the retracted end RE, a change in rotational torque occurs locally in the transition range in which the pin member 141 is positioned on the inclined portion 103a as described above. The sign of the change in torque is determined by a direction of inclination of the inclined portion 103a. When the inclined portion 103a is inclined in a direction in which X and Y are proportional to each other as illustrated in FIG. 9A, the rotating operation ring 103 is subjected to the operation reaction force F from the pin member 141 within the transition range. The operation reaction force F is decomposed into a component force Fx in the X direction and a component force Fy (force) in the Y direction due to an inclination angle of the inclined portion 103a. Then, the component force Fy acts so as to rotate the rotating operation ring 103 in the −Y direction. As a result, at the time of switching from the non-image pickup state to the image pickup state, the rotating operation ring 103 is subjected to the component force Fy in a direction of assisting the rotation in the transition range and can be smoothly switched to the image pickup state. Further, when the rotating operation ring 103 is brought into abutment against the wide angle end WE during capturing, the rotating operation ring 103 is subjected to a force in a direction of inhibiting the rotation and is prevented from being accidentally switched to the non-image pickup state. That is, when the rotating operation ring 103 is rotated in the first rotation range R1, the interchangeable lens 101 is in the image pickup state. When the rotating operation ring 103 is rotated in the transition range, the rotating operation ring 103 is subjected to the component force Fy for rotating toward the first rotation range R1. In this case, the component force Fy for rotating toward the first rotation range R1 is generated by the urging mechanism 140 in the transition range. More specifically, the component force Fy for rotating toward the first rotation range R1 is generated as a result of the abutment of the tapered portion 141a of the distal end portion 141b of the pin member 141 against the inclined portion 103a, which is a part of the rotating operation ring 103.

To allow the pin member 141 to climb over the inclined portion 103a, the rotating operation ring 103 is required to be rotated with larger torque. If the inclined portion 103a is inclined in the opposite direction, switching from the non-image pickup state to the image pickup state cannot be achieved smoothly due to a rotational load. Thus, while capturing is being performed at the wide angle end WE, the image pickup state may be accidentally switched to the non-image pickup state by an unintentional operation. It is considered that the direction of inclination of the inclined portion 103a, which is suggested in this embodiment, is optimal to allow the user to perform capturing without any stress. In this embodiment, the wide angle end WE is set at the switching position between the image pickup state and the non-image pickup state, and the telephoto end TE is set at another end of the image pickup state. However, the positions of the wide angle end WE and the telephoto end TE can be interchanged depending on an optical design.

The transition range is set so as to start at the wide angle end WE and extend into a region corresponding to the non-image pickup state. The reason is as follows. In the transition range, it is difficult to stop the rotating operation ring 103. Thus, when the transition range is set so as to start at the wide angle end WE and extend into a region corresponding to the image pickup state, the range available for capturing is narrowed.

FIG. 9B is a schematic graph having the horizontal axis representing the movement amount M of the movable portion 106a of the zoom detection unit 106 and the vertical axis representing the output change Output (%) of the zoom detection unit 106. The zoom detection unit 106 is a sensor which detects information relating to movement based on a relative change in output of the zoom detection unit 106 in the detection range. As described above, the movement amount M of the zoom lens unit 110 is calculated from the rotation amount of the rotating operation ring 103 based on the output of the zoom detection unit 106. However, the position of the zoom lens unit 110 is not required to be detected when the interchangeable lens 101 is in the non-image pickup state. However, the movable portion 106a is moved in association with the rotating operation ring 103. Hence, the zoom detection unit 106 disadvantageously performs detection also for the range in the non-image pickup state, which does not principally require detection. Thus, for the zoom detection unit 106, a first detection range D1 and a second detection range D2 are set. In the first detection range D1, the output changes in accordance with the movement amount M of the movable portion 106a. In the second detection range D2, the output remains unchanged regardless of the movement amount M of the movable portion 106a. That is, a changing rate of the output of the zoom detection unit 106 is different for each of the first detection range D1 and the second detection range D2. Further, the changing rate of the output in the first detection range D1 is higher than the changing rate of the output in the second detection range D2. When the changing rate of the output is set differently depending on the rotation range of the rotating operation ring 103, the rotation amount of the rotating operation ring 103 in the first detection range D1 can be more finely detected than in a case in which the output is changed over the entire range. Further, the changing rate of the output of the zoom detection unit 106 is different for each of a first state in which the first rotation range R1 is opposed to the pin member 141 and a second state in which the second rotation range R2 is opposed to the pin member 141. Further, the changing rate of the output under the first state is higher than the changing rate of the output under the second state. In this embodiment, the output is set so as to remain unchanged in the second detection range D2 but may also be set to change in the second detection range D2. Further, the output under the first state changes along with the rotation of the rotating operation ring 103, and the output under the second state does not change along with the rotation of the rotating operation ring 103. Under a third state in which the third rotation range R3 is urged by the pin member 141, the changing rate of the output changes. The third rotation range R3 includes a region in which the output changes along with the rotation of the rotating operation ring 103 and a region in which the output does not change along with the rotation of the rotating operation ring 103. When the optical apparatus is used for a camera system, the first state corresponds to the image pickup state and the second state corresponds to the non-image pickup state. The third state in which the third rotation range R3 is urged by the pin member 141 corresponds to the non-image pickup state. Under the first state, the urging force from the pin member 141 is not applied to the rotating operation ring 103. The rotating operation ring 103 is held over the fixed barrel 109. Under the first state, the pin member 141 is in abutment against the fixed barrel 109. When the optical apparatus is used for a camera system, the second state is the retracted state.

A rotational position of the rotating operation ring 103, which corresponds to the switching position 106c for the zoom detection unit 106 between the first detection range D1 and the second detection range D2, is set within the transition range in which a change in rotational torque of the rotating operation ring 103 occurs locally. That is, switching between the first detection range D1 and the second detection range D2 is performed in the third rotation range R3. When the rotating operation ring 103 is rotated in the transition range as described above, the pin member 141 is positioned on the inclined portion 103a. Thus, the component force Fy is applied to the rotating operation ring 103. Hence, it is difficult to stop the rotation of the rotating operation ring 103, and the rotating operation ring 103 is returned to the position of the wide angle end WE. In other words, in the transition range, it is difficult to stop the rotation of the rotating operation ring 103. In the transition range, the rotating operation ring 103 is subjected to the component force Fy for rotating the rotating operation ring 103 in a given direction. That is, when an urging position of the pin member 141 in the third rotation range R3 is changed in a first direction from the side closer to the first rotation range R1 toward the side closer to the second rotation range R2, the rotating operation ring 103 is subjected to a force in the direction opposite to the first direction. The third rotation range R3 includes the inclined portion 103a that is inclined with respect to a plane orthogonal to the optical axis OA.

Each component has a manufacturing variation, and the outer shape of the zoom detection unit 106 or the switching position 106c is not an exception. In addition, a variation in position among the components is caused due to assembly work. It is desired that the switching position between the image pickup state and the non-image pickup state and the switching position 106c between the first detection range D1 and the second detection range D2 perfectly match with each other. In consideration of the variations, however, a perfect match therebetween is impossible to achieve. In FIG. 9B, the state of the pin member 141 is taken as an example. The section from the position of the wide angle end WE to the switching position 106c corresponds to the non-image pickup state. However, this section can be erroneously recognized as being under the “image pickup state” because the output changes in this range. When the switching position 106c is set within the transition range, however, switching to a desired state can be achieved without stopping the rotating operation ring 103 within the region in which erroneous detection may be caused because it is difficult to stop the rotating operation ring 103 in the transition range.

According to this embodiment, the optical apparatus that enables correct recognition of the image pickup state even when the switching position of the detection device is varied or shifted in the optical apparatus in which the output of the detection device is switched depending on the image pickup state can be provided.

The present disclosure has been described above in detail based on the exemplary examples thereof, but the present disclosure is not limited to those particular examples, and the present disclosure encompasses various modes without departing from the gist of the present disclosure. Further, the above-mentioned embodiments are each merely one example of the present disclosure, and the respective examples can be combined as appropriate.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-103808, filed Jun. 27, 2024, which is hereby incorporated by reference herein in its entirety.

What is claimed is:

1. An optical apparatus comprising:
a rotating member configured to allow an optical element to be moved in a direction along an optical axis when being rotated about the optical axis;
a protruding member configured to urge the rotating member in a direction different from a rotating direction of the rotating member; and
a detection unit configured to detect information relating to a position of the rotating member in the rotating direction,
wherein the rotating member includes a first region, a second region, and a third region set between the first region and the second region in the rotating direction,
wherein the rotating member is subjected to a force in the rotating direction when being urged by the protruding member in the third region, and
wherein a changing rate of an output of the detection unit is different for each of a first state in which the first region is opposed to the protruding member and a second state in which the second region is opposed to the protruding member.

2. The optical apparatus according to claim 1, wherein, when an urging position of the protruding member in the third region is changed in a first direction from a side close to the first region toward a side close to the second region, the rotating member is subjected to a force in a direction opposite to the first direction.

3. The optical apparatus according to claim 1, wherein the changing rate of the output under the first state is higher than the changing rate of the output under the second state.

4. The optical apparatus according to claim 3, wherein the output under the first state changes along with rotation of the rotating member, and the output under the second state remains unchanged along with the rotation of the rotating member.

5. The optical apparatus according to claim 1, wherein the changing rate of the output changes under a third state in which the third region is urged by the protruding member.

6. The optical apparatus according to claim 5, wherein the third region includes a region in which the output changes along with rotation of the rotating member and a region in which the output remains unchanged along with the rotation of the rotating member.

7. The optical apparatus according to claim 1, wherein, when the optical apparatus is used for a camera system, the first state corresponds to an image pickup state and the second state corresponds to a non-image-pickup state.

8. The optical apparatus according to claim 7, wherein a third state in which the third region is urged by the protruding member corresponds to the non-image pickup state.

9. The optical apparatus according to claim 1, wherein the third region includes an inclined portion that is inclined with respect to a plane orthogonal to the optical axis.

10. The optical apparatus according to claim 1, wherein an urging force from the protruding member is unapplied to the rotating member under the first state.

11. The optical apparatus according to claim 10, further comprising a holding member configured to hold the rotating member,
wherein the protruding member is in abutment against the holding member under the first state.

12. The optical apparatus according to claim 1, wherein a tactile clicking sensation perceived by a user is produced by a reaction force from the rotating member to the protruding member.

13. The optical apparatus according to claim 1, further comprising a retracting mechanism that allows the optical element to be retracted,
wherein, when the optical apparatus is used for a camera system, the second state corresponds to a retracted state.

14. The optical apparatus according to claim 1, wherein the optical apparatus is mountable to and removable from a camera main body.

15. A camera system comprising:
the optical apparatus of claim 1; and a camera main body.
